(19) United States
(12) Patent Application Publication
(10) Pub. No.: US 2019/0344784 A1
(43) Pub. Date: Nov. 14, 2019

(54) VEHICLE COLLISION MITIGATION APPARATUS AND METHOD

(71) Applicant: Mando Corporation, Pyeongtaek-si (JP)

(72) Inventor: Kwan Sun You, Yongin-si (KR)

(21) Appl. No.: 16/410,495

(22) Filed: May 13, 2019

(30) Foreign Application Priority Data
May 14, 2018 (KR) 10-2018-0054623

(51) Int. Cl. B60W 30/085; B60W 10/20; B60W 10/22; B60W 10/04; B60W 30/095; B60N 2/427; B62D 15/02; B60G 17/0195; B60G 17/0165

(52) U.S. Cl. CPC B60W 30/085; B60G 2500/30; B60W 10/22; B60W 10/04; B60W 30/0956; B60N 2/42736; B62D 15/0265; B60G 17/0195; B60G 17/0165; B60N 2/42745; B60W 2550/20; B60W 2400/00; B60W 2710/20; B60W 2710/226; B60W 2720/106; B60W 2510/30; B60W 2710/30; B60G 2800/242; B60G 2500/10; B60W 10/20

(57) ABSTRACT

The present disclosure provides a vehicle collision mitigation apparatus and method, in which it is determined whether or not a collision will occur between a target vehicle and a lateral side of a host vehicle based on the paths of the host vehicle and the target vehicle, and if a collision is unavoidable, a traveling state, including a vehicle speed, steering, a suspension, or a position of a seat, is changed such that the impact caused by the collision is reduced. According to the present disclosure, it is possible to minimize damage due to the collision of the target vehicle with the lateral side of the host vehicle.

### CROSS REFERENCE TO RELATED APPLICATION

This application claims priority from Korean Patent Application No. 10-2018-0054623, filed on May 14, 2018, which is hereby incorporated by reference for all purposes as if fully set forth herein.

### BACKGROUND OF THE INVENTION

### 1. Field of the Invention

The present disclosure relates to a vehicle collision mitigation apparatus and method.

### 2. Description of the Prior Art

Generally, vehicles are provided with detecting devices, configured to recognize objects outside the vehicle, and with vehicle control devices. These devices assist a driver in driving and allow the driver to drive safely. Systems for preventing collisions, such as Junction Crossing (JC), which operates an Automatic Emergency Brake (AEB) when a collision risk arises between a preceding target vehicle and a host vehicle, are provided for safe driving of a vehicle.

Such systems may also be applied to prevent a collision with a target vehicle traveling in a direction intersecting the traveling route of a host vehicle at an intersection. However, when a collision is unavoidable because a collision of a target vehicle with a lateral side of the host vehicle cannot be avoided, a technique for minimizing damage to the host vehicle is required.

### SUMMARY OF THE INVENTION

In view of the foregoing background, an aspect of the present disclosure is to provide a vehicle collision mitigation apparatus and method that are capable of minimizing damage at the time of a side collision by changing the running state of a host vehicle if the collision of a target vehicle with a lateral side of the host vehicle is unavoidable.

Another aspect of the present disclosure is to provide a vehicle collision mitigation apparatus and method that are capable of minimizing damage at the time of a side collision by further taking into account peripheral information of a host vehicle if the collision of a target vehicle with a lateral side of the host vehicle is unavoidable.

In order to achieve the aspects described above, in one aspect, the present disclosure provides an apparatus for assisting driving of a host vehicle, including: at least one first sensor detecting vehicle information of the host vehicle; at least one second sensor detecting a target vehicle around the host vehicle; and a controller configured to determine a path of the host vehicle based on vehicle information of the host vehicle; determine a path of the target vehicle based on a result of detecting the target vehicle; determine whether a collision of the target vehicle with a lateral side of the host vehicle is unavoidable based on the path of the host vehicle and the path of the target vehicle; and change a traveling state of the host vehicle to a state in which an impact caused by the collision is reduced if the collision is unavoidable, wherein the controller is further configured to determine the state in which the impact is reduced, based on an estimated impact amount for the host vehicle and a passenger of the host vehicle determined based on an estimated position of the collision, and determine the estimated impact amount by weighting an impact amount on the passenger than an impact amount on the host vehicle.

In another aspect, the present disclosure provides a method for assisting driving of a host vehicle, the method including: detecting vehicle information of the host vehicle; detecting a target vehicle around the host vehicle; determining a path of the host vehicle based on vehicle information of the host vehicle; determining a path of the target vehicle based on a result of detecting the target vehicle; determining whether a collision of the target vehicle with the lateral side of the host vehicle is unavoidable based on the path of the host vehicle and the path of the target vehicle; and changing the traveling state of the host vehicle to a state in which an impact caused by the collision is reduced if the collision is unavoidable, wherein the changing the traveling state of the host vehicle further comprising determining an estimated impact amount for the host vehicle and a passenger of the host vehicle determined based on an estimated position of the collision, and determining the estimated impact amount by weighting an impact amount on the passenger than an impact amount on the host vehicle.

As described above, according to the present disclosure, it is possible to provide a vehicle collision mitigation apparatus and method that are capable of minimizing damage at the time of a side collision by changing the running state of a host vehicle if the collision of a target vehicle with a lateral side of the host vehicle is unavoidable.

Further, according to the present disclosure, it is possible to provide a vehicle collision mitigation apparatus and method that are capable of minimizing damage at the time of a side collision by further taking into account peripheral information of a host vehicle if the collision of a target vehicle with a lateral side of the host vehicle is unavoidable.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a block diagram of a vehicle collision mitigation apparatus according to the present disclosure;

FIG. 2 is a block diagram of a vehicle controller included in the collision mitigation apparatus of a vehicle according to the present disclosure;

FIG. 3 is a view schematically illustrating a situation in which a host vehicle may collide with a target vehicle at an intersection;

FIG. 4 is a view for explaining division of a lateral side of a host vehicle, with which a target vehicle collides, into a plurality of areas and setting the areas according to the present disclosure;

FIG. 5 is a view for explaining changing the vehicle speed of a host vehicle at the time of a collision according to the present disclosure;

FIG. 6 is a view for explaining changing the steering of a host vehicle at the time of a collision according to the present disclosure;

FIG. 7 is a block diagram of a vehicle collision mitigation apparatus according to another example of the present disclosure;

FIG. 8 is a view for explaining correcting the traveling state of a host vehicle in consideration of peripheral objects according to the present disclosure;

FIG. 9 is a flowchart of a vehicle collision mitigation method according to the present disclosure; and

FIG. 10 is a flowchart of a vehicle collision mitigation method in consideration of peripheral objects according to the present disclosure.

### DETAILED DESCRIPTION OF THE EXEMPLARY EMBODIMENTS

Hereinafter, embodiments of the present disclosure will be described in detail with reference to the accompanying drawings. In designating elements of the drawings by reference numerals, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

In addition, terms, such as first, second, A, B, (a), (b) or the like may be used herein when describing components of the present disclosure. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

In the present disclosure, the term “host vehicle” means a vehicle, to which embodiments of the present disclosure are applied. The term “target vehicle” means a vehicle that travels on a path where the vehicle is likely to collide with a lateral side of the host vehicle. The term “traveling state of the host vehicle” means various states of the host vehicle that can be controlled in relation to impact reduction at the time of collision, such as vehicle speed, steering, suspension, and seat state of the host vehicle, and whether or not a driver and a passenger are riding in the host vehicle. The term “peripheral objects” means objects capable of being collided with, such as vehicles and guard rails, which are sensed within a predetermined range with reference to the host vehicle, in addition to the target vehicle.

The present disclosure will be described on the premise that there is a possibility that a lane in which the host vehicle travels at an intersection intersects another lane in which the target vehicle travels and that the target vehicle may collide with the lateral side of the host vehicle. However, the present disclosure is not limited thereto, and when the target vehicle is likely to collide with the lateral side of the host vehicle, the contents of the present disclosure can be substantially equally applied, except for inapplicable cases.

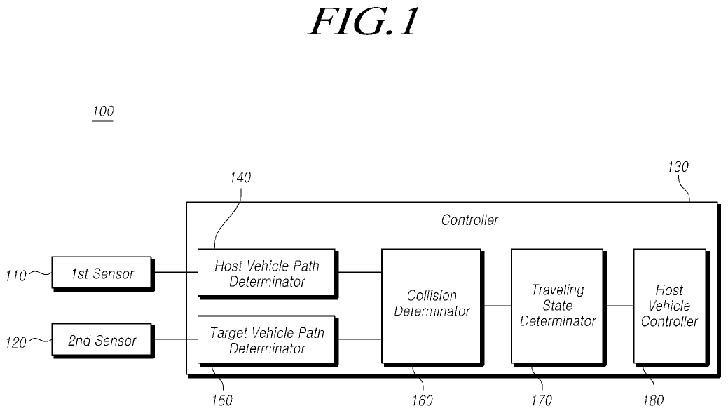

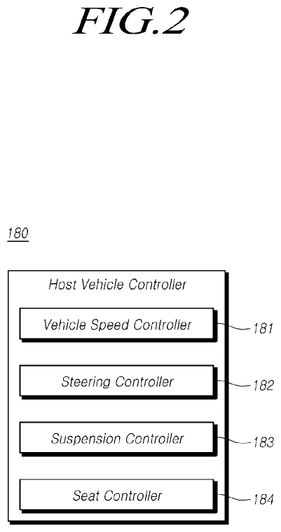

FIG. 1 is a block diagram of a vehicle collision mitigation apparatus according to the present disclosure. FIG. 2 is a block diagram of a vehicle controller included in the collision mitigation apparatus of a vehicle according to the present disclosure.

Referring to FIG. 1, a vehicle collision mitigation apparatus 100 according to embodiments of the present disclosure includes at least one first sensor 110 configured to detect vehicle information of a host vehicle, at least one second sensor 120 configured to detect a target vehicle in the vicinity of the host vehicle, and a controller 130 configured to: determine the path of the host vehicle based on vehicle information of the host vehicle, determine the path of the target vehicle based on a result of detecting the target vehicle, determine whether or not a collision of the target vehicle with a lateral side of the host vehicle is unavoidable based on the path of the host vehicle and the path of the target vehicle, and change the traveling state of the host vehicle such that an impact resulting from the collision is reduced if the collision is unavoidable.

Referring to FIG. 1, the first sensor 110 may include at least one in-vehicle sensor module mounted to the host vehicle so as to sense various information of the host vehicle and process sensed vehicle information. The vehicle information of the host vehicle obtained by the first sensor 110 may include information necessary for determining the traveling path of the host vehicle. For example, the vehicle information of the host vehicle may include information on the vehicle speed, the gear position, the yaw rate, the steering angle, and the turn signal of the host vehicle. The vehicle information of the host vehicle may also include information such as the state of the suspension or the state of the seat of the host vehicle, and whether or not the driver and the passenger are riding in the host vehicle.

The in-vehicle sensor module included in the first sensor 110 means a sensor for detecting in-vehicle information. For example, the in-vehicle sensor module may include a vehicle speed sensor configured to detect a vehicle speed, a gear position sensor configured to detect a gear position, a yaw rate sensor configured to detect a yaw rate, a steering angle sensor configured to sense a steering angle of the vehicle, or a turn signal sensor configured to sense turn signal information. In addition, the first sensor 110 may include a sensor that senses the damping force of the suspension of the vehicle, a sensor that senses the position of a seat or the inclination of a backrest, a sensor that detects the presence or absence of a passenger in each seat, and so on. As described above, the first sensor 110 is not limited to any specific sensor, as long as it can detect various vehicle information by being provided in the vehicle.

The second sensor 120 may include at least one sensor mounted to the host vehicle so as to sense the target vehicle in the vicinity of the host vehicle and to process sensed data. The periphery of the host vehicle means a range that can be sensed using the second sensor 120, or a range of a predetermined radius in the vicinity of the host vehicle.

The second sensor 120 may include at least one of a camera, a radar, a lidar, an ultrasonic or infrared camera for detecting the target vehicle. In particular, the second sensor 120 may include a corner radar or a lidar in order to sense the target vehicle traveling at an intersection toward a lateral side of the vehicle.

According to one example, the second sensor 120 may include a camera. For example, the camera may include an image sensor, configured to have a field of view of the interior or exterior of the host vehicle so as to capture image data, and a processor configured to process the captured image data.

As an example, the image sensor may be mounted to the vehicle so as to have a field of view of the interior or exterior of the host vehicle. At least one image sensor may be mounted on each part of the vehicle so as to have a view towards a front side, a lateral side, or a rear side of the vehicle.

Since the image information captured by the image sensor is composed of image data, it may mean image data captured by the image sensor. Hereinafter, image information, captured by the image sensor in the present disclosure, means image data captured by the image sensor.

The image data captured by the image sensor may be processed in the processor. The processor may be operable to process image data captured by the image sensor.

The processor may be implemented in hardware using at least one of electric units capable of processing image data and performing other functions (such as Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, micro-controllers, or microprocessors.

The second sensor 120 may further include at least one of a radar, a lidar, an ultrasonic or infrared camera for detecting the target vehicle.

Meanwhile, a radar sensor or radar system used in the present disclosure may include at least one radar sensor unit, for example, at least one of a front-side detecting radar sensor mounted on the front side of the vehicle, a rear-side detecting radar sensor mounted on the rear side of the vehicle, or a lateral side or lateral-rear-side detecting radar sensor mounted on each lateral side of the vehicle. Such a radar sensor or radar system may analyze the transmission and reception signals so as to process the data, thereby detecting information on an object, and may include an Electronic Control Unit (ECU) or a processor for this purpose. Data transmission or signal communication from the radar sensor to the ECU may utilize a communication link such as an appropriate vehicle network bus or the like.

Such a radar sensor includes at least one transmission antenna that transmits a radar signal and at least one reception antenna that receives a reflection signal reflected from an object.

Meanwhile, the radar sensor according to the present embodiments may adopt a multi-dimensional antenna arrangement and a Multiple-Input Multiple-Output (MIMO) signal transmission and reception scheme in order to form a virtual antenna aperture larger than an actual antenna aperture.

For example, in order to achieve horizontal and vertical angular precision and resolution, a two-dimensional antenna array is used. When using a two-dimensional antenna array, the antenna array may transmit and receive through two scans (temporally multiplexed) in the horizontal and vertical directions, respectively, and MIMO may be used in addition to the horizontal and vertical scans (time multiplexing) of the two-dimensional radar.

More specifically, in the radar sensor according to the present embodiment, a two-dimensional antenna array configuration including a transmission antenna section including a total of 12 transmission antennas Tx and a reception antenna section including 16 reception antennas Rx may be adopted. Consequently, the antenna array configuration may have an arrangement of a total of 192 virtual reception antennas.

The transmission antenna section may include three transmission antenna groups, each including four transmission antennas, in which the first transmission antenna group is spaced apart from the second transmission antenna group by a predetermined distance in the vertical direction, and the first or second transmission antenna group may be spaced apart from the third transmission antenna group by a predetermined distance D in the horizontal direction.

In addition, the reception antenna section may include four reception antenna groups, each including four reception antennas, in which respective reception antenna groups are disposed to be spaced apart from each other in the vertical direction. The reception antenna section may be disposed between the first transmission antenna group and the third transmission antenna group, which are spaced apart from each other in the horizontal direction.

Further, in another embodiment, the antennas of the radar sensor are arranged in a two-dimensional antenna array. For example, each antenna patch has a rhombus grid arrangement, thereby reducing unnecessary side lobes.

Alternatively, the two-dimensional antenna arrangement may include a V-shaped antenna array in which a plurality of radiation patches are arranged in a V shape. More specifically, the two-dimensional antenna arrangement may include two V-shaped antenna arrays. At this time, a single feed is made to the apex of each V-shaped antenna array.

Alternatively, the two-dimensional antenna arrangement may include a X-shaped antenna array in which a plurality of radiation patches are arranged in an X shape. More specifically, the two-dimensional antenna arrangement may include two V-shaped antenna arrays. At this time, a single feed is made to the center of each X-shaped antenna array.

The radar sensor according to the present disclosure may utilize a MIMO antenna system in order to implement detecting accuracy or resolution in vertical and horizontal directions.

More specifically, in the MIMO system, respective transmission antennas may transmit signals having independent waveforms that are differentiated from each other. That is, each transmission antenna is capable of transmitting a signal of an independent waveform differentiated from those of the other transmit antennas, and each reception antenna is capable of determining from which transmission antenna the reflected signal reflected from the object was transmitted due to the different waveforms of these signals.

In addition, the radar sensor according to the present embodiment may be configured to include a radar housing that accommodates a board and a circuit including the transmission and reception antennas, and a radome that constitutes the outer appearance of the radar housing. At this time, the radome is made of a material capable of reducing the attenuation of transmitted and received radar signals, and the radome may be constituted with the front and rear bumpers, the grill, or the side bodies of the vehicle, or the outer surface of a vehicle component.

That is, the radome of the radar sensor may be mounted inside a vehicle grill, a bumper, a vehicle body, or the like, or may be disposed as a portion of a component constituting the outer surface of the vehicle, such as the vehicle grille, the bumper, or a portion of the vehicle body, thereby providing convenience of mounting the radar sensor while improving the aesthetic sense of the vehicle.

The lidar may include a laser transmitter, a laser receiver, and a processor. The lidar may be implemented in a Time-Of-Flight (TOF) type or a phase-shift type.

The TOF-type lidar emits a laser pulse signal and receives a reflected pulse signal reflected from an object. The lidar is capable of measuring the distance to the object based on the time at which the laser pulse signal is emitted and the time at which the reflected pulse signal is received. In addition, the lidar is capable of measuring a speed relative to the object based on the change in distance over time.

Meanwhile, the phase-shift-type lidar is capable of emitting a laser beam continuously modulated with a specific frequency and measuring the time and the distance to the object based on an amount of a phase change of a signal reflected from the object. In addition, the lidar is capable of measuring a relative speed relative to the object based on the change in distance over time.

The lidar is capable of detecting the object based on the transmitted laser, and is capable of detecting the distance to the detected object and the relative speed. When the object is a stationary object (e.g., a street tree, a street lamp, a traffic light, a traffic sign, etc.), the lidar is capable of detecting the traveling speed of the vehicle based on the TOF by the object.

The ultrasonic sensor may include an ultrasonic transmitter, an ultrasonic receiver, and a processor.

The ultrasonic sensor is capable of detecting the object based on the transmitted ultrasonic waves, and is capable of detecting the distance to the detected object and the relative speed. When the object is a stationary object (e.g., a street tree, a street lamp, a traffic light, a traffic sign, etc.), the ultrasonic sensor is capable of detecting the traveling speed of the vehicle based on the TOF by the object.

The second sensor 120 may detect the target vehicle using one or more sensors having different detecting areas. The second sensor 120 may perform detecting and tracking of the target vehicle by applying the fusion of sensors to at least two overlapping detecting areas.

The controller 130 is capable of controlling the overall operation of the vehicle collision mitigation apparatus 100. The controller 130 is capable of controlling various operations of the vehicle, responsive to the processing of data sensed by the first sensor and the second sensor. According to one embodiment, the controller 130 may be implemented as an ECU that performs a series of operations to predict a collision with the target vehicle and change the traveling state of the host vehicle. Alternatively, the controller 130 may be implemented to perform not only control of the vehicle collision mitigation apparatus 100, but also to function as a controller that controls the overall operation of the vehicle.

The controller 130 includes: a host vehicle path determinator 140 configured to determine the path of the host vehicle based on the vehicle information of the host vehicle, which is sensed by the first sensor 110; a target vehicle path determinator 150 configured to determine the path of the target vehicle based on the result obtained by detecting the target vehicle by the second sensor 120; a collision determinator 160 configured to determine whether a collision of the target vehicle with a lateral side of the vehicle is unavoidable based on the path of the host vehicle and the path of the target vehicle; a traveling state determinator 170 configured to determine the traveling state of the host vehicle such that the impact resulting from the collision is reduced if a collision is unavoidable; and a host vehicle controller 180 configured to perform control such that the traveling state of the host vehicle is changed according to the determined traveling state.

The vehicle path determinator 140 may determine the path of the host vehicle based on vehicle information such as the vehicle speed, the gear position, the yaw rate, the steering angle, or the turn signals of the host vehicle, which are sensed by the first sensor 110. The host vehicle path determinator 140 may estimate a path up to a predetermined time on the premise that the host vehicle travels according to the current vehicle information.

According to an example, the host vehicle path determinator 140 may perform path determination when the host vehicle approaches an intersection within a predetermined distance. The host vehicle path determinator 140 may determine the path of the host vehicle up to the time when the host vehicle passes through the intersection. However, this is merely an example, and the present disclosure is not limited thereto. The path determination of the host vehicle may also be performed in other situations as needed.

The target vehicle path determinator 150 may determine the path of the target vehicle on the basis on the position information or the like of the target vehicle, which is detected by the second sensor 120. For example, when the second sensor 120 senses the target vehicle at predetermined time intervals, the target vehicle path determinator 150 may determine the path of the target vehicle based on the position of the target vehicle, which is sensed at a predetermined time interval.

According to an example, the second sensor 120 may perform an experiment for detecting each of target vehicles traveling in various paths to acquire data on the position of each of the target vehicles in advance, and the target vehicle path determinator 150 may determine the paths of the target vehicles based on the acquired data.

However, this is merely an example, and the present disclosure is not limited thereto. The method of determining the path of the target vehicle according to the result of detection by the second sensor 120 is not limited to a specific method.

According to an example, the target vehicle path determinator 150 may perform path determination when the host vehicle approaches an intersection within a predetermined distance. The target vehicle path determinator 150 may determine the path of the target vehicle up to the time when the host vehicle passes through the intersection. However, this is merely an example, and the present disclosure is not limited thereto. The path determination of the target vehicle may also be performed in other situations as needed.

The collision determinator 160 may determine whether a collision of the target vehicle with a lateral side of the host vehicle is unavoidable based on the path of the host vehicle and the path of the target vehicle. The collision determinator 160 may determine whether there is a possibility of a collision between the target vehicle and the host vehicle based on the position and the time at which the path of the host vehicle and the path of the target vehicle intersect each other.

If there is a possibility of a collision, the collision determinator 160 may determine whether the collision with the target vehicle is avoidable when a collision avoidance system provided in the host vehicle is driven. In this case, according to an example, the collision determinator 160 may output a signal for driving the collision avoidance system.

If a collision with the target vehicle is unavoidable even if the collision avoidance system is driven, the collision determinator 160 may estimate the position and the time at which the path of the host vehicle and the path of the target vehicle intersect each other as the collision position and collision time with respect to the lateral side of the host vehicle.

The traveling state determinator 170 may determine the traveling state of the host vehicle with respect to the state where the impact resulting from the collision is reduced based on the result of the determination made by the collision determinator 160. The traveling state determinator 170 may determine an estimated impact amount for the host vehicle and a passenger based on the collision position estimated by the collision determinator 160.

According to an example, the second sensor 120 may further detect the size of the target vehicle, and the traveling state determinator 170 may adjust the value of the estimated impact amount according to the size of the target vehicle. The traveling state determinator 170 may recognize the target vehicle from the image data or the detecting data acquired by the second sensor 120 and may adjust the numerical value of the estimated impact amount by taking into account the information such as the vehicle type and the size of the target vehicle.

In addition, the traveling state determinator 170 may adjust the numerical value of the estimated impact amount by taking into account the information on the riding positions of the driver and the passenger. To this end, the second sensor 120 may further include a camera having a field of view of the interior of the host vehicle, a pressure sensor for each seat, or the like.

To this end, data for an estimated impact amount may be acquired in advance by dividing the left and right sides of the vehicle into a plurality of collision areas, and performing an experiment to measure the impact amount applied to the host vehicle and the passenger according to each collision area. The data may be acquired for various traveling speeds of the host vehicle and the target vehicle. In addition, the data may be acquired for various sizes of the target vehicle.

The traveling state determinator 170 may determine whether or not there are candidate collision areas that may receive an impact amount smaller than that in the collision area in which the estimated impact amount is determined on the lateral side of the host vehicle. When there are candidate collision areas, the traveling state determinator 170 may determine whether or not there are candidate collision areas where a collision with the target vehicle can be induced according to the change of the traveling state of the host vehicle. The traveling state determinator 170 may determine the collision area that receives the smallest impact amount among the candidate collision areas where a collision can be induced.

According to an example, the determination of the impact amount may be determined by weighting the impact amount on a passenger who is present in the vehicle, rather than the impact amount on the host vehicle. That is, when the impact amount on an area corresponding to a seat portion and the impact amount on an area corresponding to the trunk portion are the same in the lateral sides of the vehicle, the area corresponding to the trunk portion may be determined as the collision area. Further, the determination of the impact amount may be determined differently depending on whether or not a passenger is present.

The traveling state determinator 170 may determine the traveling state of the host vehicle that causes the target vehicle to collide with the determined impact area. The traveling state determinator 170 may determine the change value of the traveling state based on the determined traveling state of the host vehicle and the current traveling state of the host vehicle. For example, when it is estimated that the target vehicle will collide with an area corresponding to the left side rear seat of the host vehicle, the traveling state determinator 170 may determine an increase value of the vehicle speed that causes the target vehicle to collide with an area corresponding to the left side trunk of the host vehicle.

When the collision area is determined, the traveling state determinator 170 may further determine the traveling state in which the impact amount is reduced in the determined collision area. The traveling state determinator 170 may determine the damping force of the suspension of the host vehicle or the height of the suspension that causes the impact amount to be reduced in the determined collision area. Typically, the height of the suspension is lowered so as to prevent overturn at the time of collision, and the lowered height may be adjusted depending on the impact amount. In addition, the traveling state determinator 170 may determine the longitudinal position and height of a seat, the inclination of the backrest of the seat, and the like that causes the impact amount to be reduced in the determined collision area.

For this purpose, if an experiment is performed to measure the impact amount on each impact area of the host vehicle, it is possible to acquire in advance data on the estimated impact amount according to the adjustment of the suspension and the seat. The data may be acquired for each of the case where the passenger is an adult and the case where the passenger is a child.

The host vehicle controller 180 may change at least one of the vehicle speed, the steering, the suspension, or the seat position of the host vehicle, which are aspects of the traveling state of the host vehicle, based on changed values of the traveling state determined by the traveling state determinator 170. Referring to FIG. 2, the vehicle controller 180 may include a vehicle speed controller 181 configured to control the vehicle speed of the host vehicle, a steering controller 182 configured to change the steering of the host vehicle, a suspension controller 183 configured to change the suspension of the host vehicle, and a seat controller 184 configured to change a seat position.

The vehicle speed controller 181 may control an electronically controlled brake or an electronically controlled throttle according to the changed value of the vehicle speed determined by the traveling state determinator 170 so as to decrease or increase the vehicle speed of the host vehicle. However, this is merely an example, and the present disclosure is not limited to any specific method, as long as the vehicle speed can be changed under the control of the vehicle speed controller 181.

The steering controller 182 may change the advancing direction of the vehicle by controlling the steering apparatus in accordance with the changed value of steering determined by the traveling state determinator 170. For example, in the case where the target vehicle approaches from the left side, when a steering value to the right side is determined, the steering controller 182 may control the steering apparatus such that the host vehicle is steered to the right side.

The suspension controller 183 may change the damping force of the suspension or the height of the host vehicle, which is determined with reference to the suspension, according to the changed value of the suspension determined by the traveling state determinator 170. The suspension controller 183 may adjust the pressure of the damper of the suspension by controlling the driving of a solenoid valve within the suspension, thereby changing the damping force, which is a force that suppresses the vehicle body from shaking or vibrating up and down by the expansion and contraction action of a spring within the suspension.

The suspension controller 183 may control the driving of the solenoid valve within the suspension so as to reduce the pressure of the hydraulic cylinder of the damper, thereby lowering the height of the vehicle body.

It is possible to prevent phenomena that may occur when the vehicle speed or steering is suddenly changed in order to reduce the impact amount at the time of a collision under the control of the suspension controller 183. For example, by controlling the state of the suspension, a dive phenomenon, in which the vehicle body is tilted forwards due to an inertial force directed forward when the vehicle is suddenly braked, a squat phenomenon, in which the vehicle body is tilted backwards due to an inertial force directed rearwards, and a rolling phenomenon, in which the vehicle body is tilted outwards due to centrifugal force directed towards the outside during a rapid curve, can be quickly prevented, and the impact amount at the time of collision can be reduced.

The seat controller 184 may change the longitudinal position of the seat, the height of the seat, the inclination of the backrest of the seat, or the like according to the changed value of the position of the seat determined by the traveling state determinator 170. The seat controller 184 may control a motor that moves the seat back and forth, a motor that moves the seat up and down, and a motor that adjusts the inclination of the backrest, thereby reducing the impact applied to a passenger at the time of collision.

For example, in order to reduce the amount of impact at the time of collision, when sudden braking is performed, the seat controller 184 may move the seat backwards or increase the height of the seat in order to prevent a collision with a steering wheel or a dashboard. Alternatively, in the case of sudden acceleration, the seat controller 184 may adjust the inclination of the backrest to reduce the impact applied to the neck of the occupant.

According to an example, the vehicle collision mitigation apparatus 100 further may include a communicator performs functions for performing vehicle-to-vehicle communication, vehicle-to-infrastructure communication, vehicle-to-server communication, in-vehicle communication, and the like. For this purpose, the communicator may be composed of a transmission module and a reception module. For example, the communicator may include a broadcast reception module, a wireless Internet module, a short-range communication module, a position information module, an optical communication module, a V2X communication module, and the like.

According to this, if the collision of the target vehicle with a lateral side of the host vehicle is unavoidable, the traveling state of the vehicle may be changed so as to minimize the damage in a side collision.

In one embodiment, the controller may be implemented as a Domain Control Unit (DCU) configured to control at least one driver assistance system module provided in the vehicle.

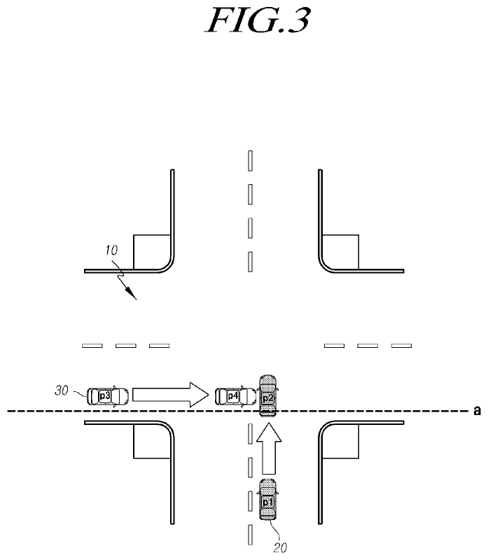

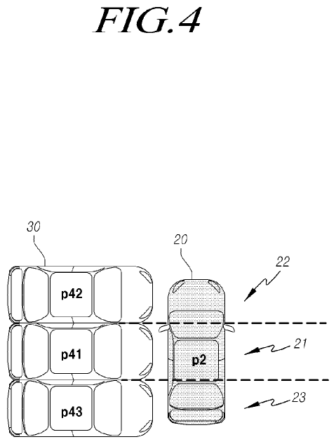

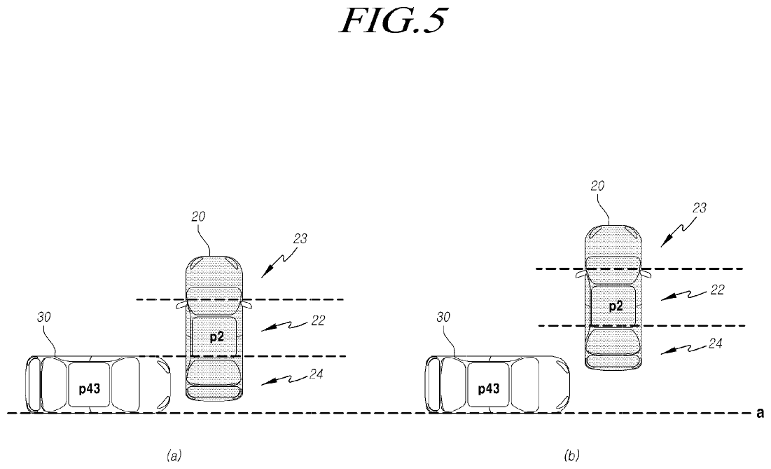

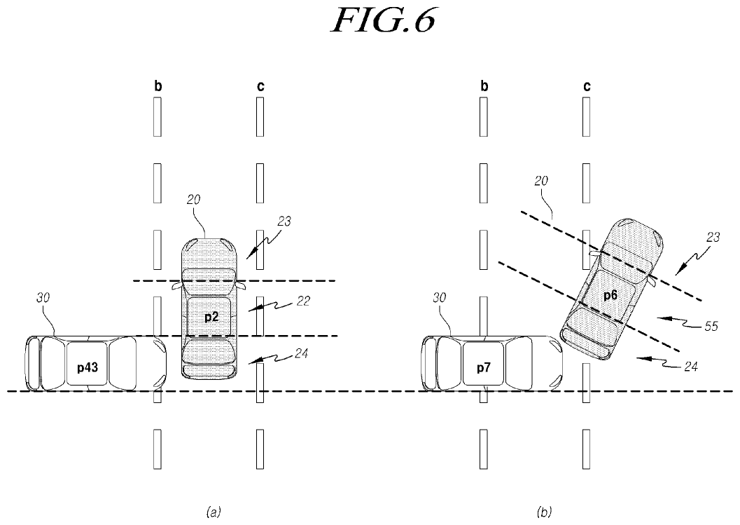

FIG. 3 is a view schematically illustrating a situation in which a host vehicle may collide with a target vehicle at an intersection. FIG. 4 is a view for explaining division of a lateral side of a host vehicle, with which a target vehicle collides, into a plurality of areas and setting the areas according to the present disclosure. FIG. 5 is a view for explaining changing the vehicle speed of a host vehicle at the time of the collision according to the present disclosure. FIG. 6 is a view for explaining changing the steering of a host vehicle at the time of the collision according to the present disclosure.

Referring to FIG. 3, it is illustrated that the host vehicle 20 enters the intersection 10. When the host vehicle 20 approaches the intersection within a predetermined distance, for example, when the vehicle enters a position p1, the host vehicle path determinator 140 may perform path determination based on the information sensed by the first sensor 110.

When the host vehicle 20 approaches the intersection within a predetermined distance, for example, when the vehicle enters the position p1, the host vehicle path determinator 150 of the host vehicle 20 may perform path determination on the target vehicle 30. However, this is merely an example, and the path determination on the host vehicle 20 and the path determination on the target vehicle 30 may be started at different positions, respectively.

The collision determinator 160 of the host vehicle may determine whether a collision of the target vehicle with the lateral side of the host vehicle is unavoidable based on the path of the host vehicle and the path of the target vehicle. As illustrated in FIG. 3, when it is determined that the target vehicle 30 travels straight along a straight line a and travels at a position p4 when the host vehicle 20 travels at the position p2, it may be determined that the target vehicle 30 and the host vehicle are likely to collide with each other.

If there is a possibility of a collision, the collision determinator 160 may determine whether the collision with the target vehicle 30 is avoidable when a collision avoidance system provided in the host vehicle 20 is driven. In this case, in an example, the collision determinator 160 may output a signal for driving the collision avoidance system.

If the collision with the target vehicle 30 is unavoidable even if the collision avoidance system is driven, the collision determinator 160 may determine the positions p2 and p4 and the time at which the path of the host vehicle 20 and the path of the target vehicle 30 intersect each other as the collision position and collision time with respect to the lateral side of the host vehicle 20.

The traveling state determinator 170 may determine an estimated impact amount for the host vehicle and a passenger based on the collision position estimated by the collision determinator 160. To this end, data for an estimated impact amount may be acquired in advance by dividing the left and right sides of the vehicle into a plurality of collision areas and performing an experiment to measure the impact amount applied to the host vehicle and the passenger according to each collision area.

Hereinafter, changing the traveling state in order to mitigate a collision will be described in detail with reference to the related drawings.

Referring to FIG. 4, a lateral side of the host vehicle 20 at the position p2 is divided into three areas according to an example. The lateral side of the host vehicle 20 may be divided into a seat area 21 corresponding to a portion where seats exist, a bonnet area 22 corresponding to the bonnet portion, and a trunk area 23 corresponding to the trunk portion. However, this is merely an example, and the present disclosure is not limited thereto. The lateral area of the vehicle 20 may be further subdivided.

The traveling state determinator 170 may determine whether or not there are candidate collision areas that may receive an impact amount smaller than that in the collision area in which an estimated impact amount is determined on the lateral side of the host vehicle. For example, referring to FIG. 4, it is assumed that it is determined that the target vehicle 30 collides with the seat area 21 of the host vehicle 20 at the position p41.

Generally, when colliding with the seat area 20, the impact amount transmitted to the vehicle itself and to a passenger may be the greatest. The traveling state determinator 170 may determine the bonnet area 22 where the target vehicle 30 collides at the position p42 and the trunk area 23 where the target vehicle 30 collides at the position p43 as candidate collision areas at which the collision amount is smaller than that in the seat area 21.

The traveling state determinator 170 may determine whether or not the collision of the bonnet area 22 and the trunk area 23 with the target vehicle can be induced by changing the traveling state of the host vehicle. For example, the traveling state determinator 170 may determine whether or not the target vehicle 30 collides with the bonnet area 22 ahead of the seat area 21 when the vehicle speed is decelerated. Alternatively, the traveling state determinator 170 may determine whether or not the target vehicle 30 collides with the trunk area 23 behind the seat area 21 when the vehicle speed is decelerated.

If it is possible to induce the collision for only one of the bonnet region 22 and the trunk region 23, the traveling state determinator 170 is capable of determining the area for which it is possible to induce the collision as the collision area. If it is possible to induce a collision for both the bonnet region 22 and the trunk region 23, the traveling state determinator 170 is capable of estimating the impact amount at the time of the collision with respect to each of the two areas 22 and 23.

The traveling state determinator 170 is capable of determining the area having the smaller estimated impact amount from among the two areas 22 and 23 as the collision area.

Referring to FIG. 5, it is illustrated that the collision area is changed according to the change of the vehicle speed. That is, a case is assumed in which it is determined that the target vehicle 30 collides with the trunk area 24 at the position p43 when the host vehicle 20 travels at the position p2, as illustrated in FIG. 5A. It is also assumed that it is determined that it is impossible to avoid the collision by the collision avoidance system of the host vehicle 20.

It may be determined that the impact amount when the host vehicle 20 is struck at the collision area at the position p2 is smaller than the impact amount when the host vehicle 20 is struck at the collision area at the position p5, as illustrated in FIG. 5B. In this case, the traveling state determinator 170 may determine the vehicle speed at which the host vehicle 20 collides with the target vehicle 30 at the position p5. The increase value of the vehicle speed may be determined by comparing the determined vehicle speed and the current vehicle speed.

The host vehicle controller 180 may increase the vehicle speed of the host vehicle 20 by controlling the electronically controlled throttle based on the determined increase value of the vehicle speed. Accordingly, if the collision is unavoidable, the collision position p2 according to the current traveling state may be changed such that the collision is caused at the position p5 where the impact amount is smaller.

Referring to FIG. 6, it is illustrated that the collision area is changed according to the change of the steering. That is, the case is assumed in which it is determined that the target vehicle 30 collides with the trunk area 24 at the position p43 when the host vehicle 20 travels at the position p2, as illustrated in FIG. 6A. It is also assumed that it is determined that it is impossible to avoid the collision by the collision avoidance system of the host vehicle 20.

It may be determined that the impact amount when the host vehicle 20 is struck at the collision area at the position p2 is smaller than the impact amount when the host vehicle 20 is struck at the collision area at position p6, as illustrated in FIG. 6B. In this case, the traveling state determinator 170 may determine a change value of steering at which the host vehicle 20 is struck at the position p6 with the target vehicle 30 which travels at position p7.

The host vehicle controller 180 may change the steering of the host vehicle 20 to the right by controlling the steering apparatus based on the determined change value of the steering. Accordingly, if a collision is unavoidable, the collision position p2 according to the current traveling state may be changed, so that the collision can be caused at the position p5, where the impact amount is smaller.

In the foregoing description, the case in which each of the vehicle speed and steering of the host vehicle 20 is changed described as an example. However, it is natural that the vehicle speed and steering of the host vehicle 20 can be changed at the same time in order to change the area where the host vehicle 20 collides with the target vehicle 30.

When the collision area is determined, the traveling state determinator 170 may determine the damping force of the suspension of the host vehicle or the height of the suspension that causes the impact amount to be reduced in the determined collision area. In addition, the traveling state determinator 170 may determine the longitudinal position and height of a seat, the inclination of the backrest of the seat, and the like that causes the impact amount to be reduced in the determined collision area.

The host vehicle controller 180 may change the damping force of the suspension or the height of the host vehicle, which is determined with reference to the suspension, according to the changed value of the suspension determined by the traveling state determinator 170. The suspension controller 183 may control the driving of a solenoid valve in the suspension, thereby adjusting the pressure of the damper of the suspension so as to change the damping force. In addition, the suspension controller 180 may control the driving of the solenoid valve within the suspension, thereby adjusting the pressure of the hydraulic cylinder of the damper so as to change the height of the vehicle body.

The dive phenomenon, the squat phenomenon, the rolling phenomenon, and the like, which are likely to occur when the vehicle speed or the steering is suddenly changed in order to reduce the impact amount at the time of collision, can be prevented through control of the suspension, and the impact amount at the time of a collision can be reduced.

The host vehicle controller 180 may change the longitudinal position of the seat, the height of the seat, the inclination of the backrest of the seat, and the like according to the changed value of the position of the seat determined by the traveling state determinator 170. The seat controller 184 may control a motor that moves the seat back and forth, a motor that moves the seat up and down, and a motor that adjusts the inclination of the backrest, thereby reducing the impact applied to a passenger at the time of collision.

According to this, if the collision of the target vehicle with a lateral side of the host vehicle is unavoidable, it is possible to minimize the damage in a side collision by changing the traveling state of the vehicle.

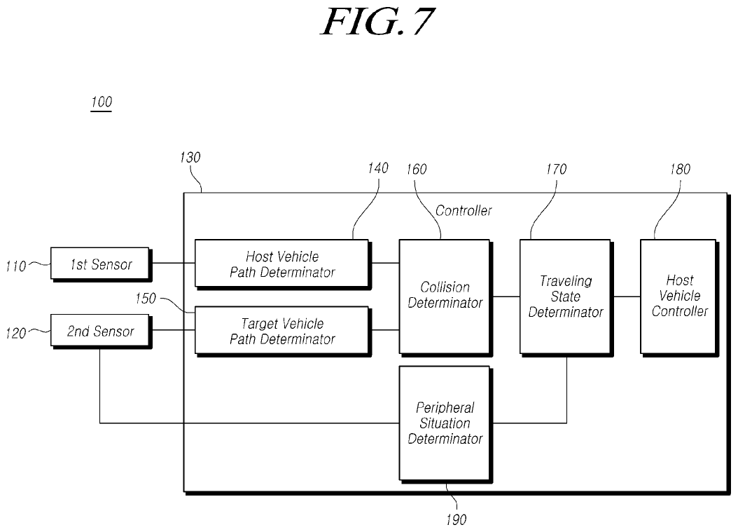

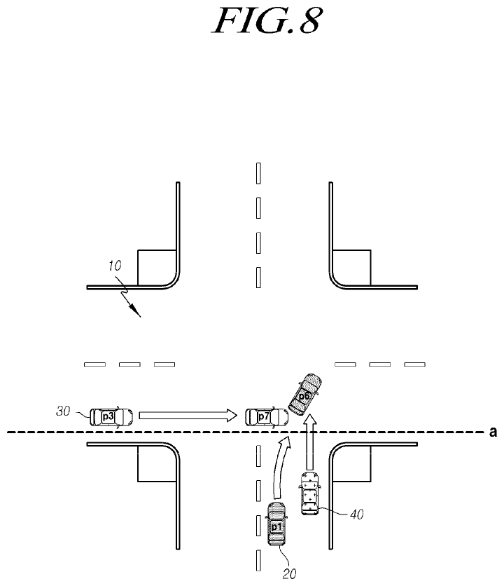

FIG. 7 is a block diagram of a vehicle collision mitigation apparatus according to another example of the present disclosure. FIG. 8 is a view for explaining correcting the traveling state of a host vehicle in consideration of peripheral objects according to the present disclosure.

Referring to FIG. 7, there is illustrated a block diagram of a vehicle collision mitigation apparatus 100 further including a peripheral situation determinator 190. Since the description of each component of the vehicle collision mitigation apparatus 100 described with reference to FIG. 1A is substantially equally applicable to that in FIG. 7, a redundant description will be omitted as much as possible.

According to one embodiment, the second sensor 120 may further sense the peripheral information of the host vehicle 20 including a lane and a peripheral object. The second sensor 120 may sense objects detected within a predetermined range with reference to the host vehicle, such as a vehicle or a guard rail, in addition to the target vehicle 30.

The peripheral situation determinator 190 may determine the position of a peripheral object with reference to the host vehicle 20 according to the current traveling state of the host vehicle 20. If necessary, the peripheral situation determinator 190 may determine the position of the peripheral object by receiving the path information of the vehicle 20 from the host vehicle path determinator 140. When the peripheral object is another vehicle, the peripheral situation determinator 190 may determine the path of the other vehicle based on the sensed position of the other vehicle.

According to an example, the peripheral situation determinator 190 may perform peripheral situation determination when the host vehicle approaches an intersection within a predetermined distance. The peripheral situation determinator 190 may determine the peripheral situation up to the time when the host vehicle passes through the intersection. However, this is merely an example, and the present disclosure is not limited thereto. The determination of the peripheral situation may also be performed in other situations as needed.

The traveling state determinator 170 may determine the traveling state of the host vehicle with respect to the state where the impact resulting from the collision is reduced based on the collision position estimated by the collision determinator 160. In this case, the traveling state determinator 170 may further consider the peripheral situation determined by the peripheral situation determinator 190.

The traveling state determinator 170 may prevent a collision with a peripheral object that may occur after a collision with the target vehicle 30 based on the peripheral information determined by the peripheral situation determinator 190. Alternatively, the running state determinator 170 may correct the traveling state of the host vehicle 20 in the state where the impact resulting from a collision with a peripheral object, which may occur after the collision with the target vehicle 30, is reduced.

Referring to FIG. 8, changing the steering for collision mitigation of the host vehicle 30 and the host vehicle 20 illustrated in FIG. 6 is illustrated at an intersection 10. With reference to FIGS. 5 and 6, it is assumed that it is determined that the impact amount at the position p5 (FIG. 5B) is smaller than the impact amount at the original collision position p2, and that the impact amount at the position p6 (FIG. 6B) is smaller than the impact amount at the position P5.

As described above, the traveling state determinator 170 may make a determination such that the host vehicle 20 collides with the target vehicle 30 at the position p6 at which the impact amount is estimated to be the smallest. In this case, however, the traveling state determinator 170 may further consider the path of another vehicle 40 traveling on the right side.

That is, the traveling state determinator 170 may further determine whether or not the host vehicle 20 collides again with the other vehicle 40 in the case where the host vehicle 20 collides with the target vehicle 30 when the host vehicle 20 progresses to the position p6. The traveling state determinator 170 may determine the impact amount resulting from the collision with the other vehicle 40. By comparing the sum of the impact amounts with the target vehicle 30 and the other vehicle 40 at the time of progressing to the position p6 with the impact amount at the time of progressing to the position p5 (FIG. 5B), the traveling state determinator 170 may determine change values of the vehicle speed and steering of the host vehicle 20 so as to make the host vehicle travel to the position where the host vehicle receives a smaller impact amount.

For the sake of convenience of description, the present disclosure has been described on the premise of two cases, i.e. the case of changing the vehicle speed and the case of changing the steering, but the present disclosure is not limited thereto. The traveling state determinator 170 may compare the impact amount according to a combination of the vehicle speed and the steering and may change the traveling state to the position where the minimum impact amount is received.

According to this, if the collision of the target vehicle with a lateral side of the host vehicle is unavoidable, it is possible to minimize the damage in a side collision by further taking into account the peripheral information of the vehicle.

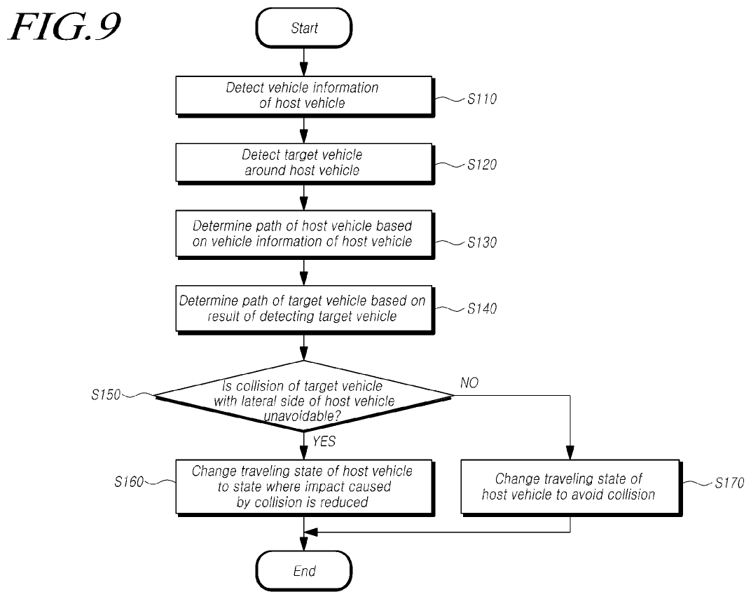

FIG. 9 is a flowchart of a vehicle collision mitigation method according to the present disclosure.

The vehicle collision mitigation method according to the present disclosure may be implemented in the vehicle collision mitigation apparatus 100 described with reference to FIG. 1A. Hereinafter, the collision mitigation method of the vehicle according to the present disclosure and the operation of the vehicle collision mitigation apparatus 100 for implementing the same will be described in detail with reference to drawings needed therefor.

Referring to FIG. 9, the vehicle information of the host vehicle may be sensed using the first sensor included in the vehicle collision mitigation apparatus 100 (S110).

The first sensor may include one or more sensors in order to acquire vehicle information such as a vehicle speed, a gear position, a yaw rate, a steering angle, and a turn signal of the host vehicle. The first sensor may sense information of a vehicle speed, a gear position, a yaw rate, a steering angle, and a turn signal lamp necessary for determining the traveling path of the host vehicle. The vehicle information of the host vehicle, which is sensed by the first sensor, may also include information such as the state of the suspension or the state of the seat of the host vehicle, and whether or not the driver and the passenger are riding in the host vehicle.

Referring to FIG. 9 again, the target vehicle in the vicinity of the host vehicle may be sensed using the second sensor included in the vehicle collision mitigation apparatus 100 (S120).

The second sensor may include at least one of a camera, a radar, a lidar, an ultrasonic or infrared camera for detecting the target vehicle. In particular, the second sensor may include a corner radar or a lidar in order to sense the target vehicle traveling at an intersection toward a lateral side of the vehicle.

The second sensor may sense the target vehicle using one or more sensors having different detecting areas. The second sensor may perform detecting and tracking of the target vehicle by applying the fusion of sensors to at least two overlapping detecting areas.

Referring to FIG. 9 again, the controller 130 included in the vehicle collision mitigation apparatus 100 may determine the path of the host vehicle based on the vehicle information of the host vehicle (S130).

The controller 130 may determine the path of the host vehicle based on vehicle information such as the vehicle speed, the gear position, the yaw rate, the steering angle, or the turn signals of the host vehicle, which are sensed by the first sensor. The controller 130 may perform path determination when the host vehicle approaches an intersection within a predetermined distance. The controller 130 may determine the path of the host vehicle up to the time when the host vehicle passes through the intersection.

Referring to FIG. 9 again, the controller 130 may determine the path of the target vehicle based on the result of detecting the target vehicle (S140).

The controller 130 may determine the path of the target vehicle on the basis on the position information or the like of the target vehicle, which is detected by the second sensor. For example, when the second sensor senses the target vehicle at predetermined time intervals, the controller 130 may determine the path of the target vehicle based on the position of the target vehicle, which is sensed at a predetermined time interval.

According to an example, the controller 130 may perform path determination when the host vehicle approaches an intersection within a predetermined distance. The controller 130 may determine the path of the target vehicle up to the time when the host vehicle passes through the intersection.

Referring to FIG. 9 again, the controller 130 may determine whether a collision of the target vehicle with a lateral side of the host vehicle is unavoidable based on the path of the host vehicle and the path of the target vehicle (S150).

The controller 130 may determine whether there is a possibility of a collision between the target vehicle and the host vehicle based on the position and the time at which the path of the host vehicle and the path of the target vehicle intersect each other. If there is the possibility of a collision, the controller 130 may determine whether the collision with the target vehicle is avoidable when a collision avoidance system provided in the host vehicle is driven. In this case, according to an example, the controller 130 may output a signal for driving the collision avoidance system.

If a collision with the target vehicle is unavoidable even if the collision avoidance system is driven, the controller 130 may determine at which position of the host vehicle the target vehicle will collide based on the current traveling state of the host vehicle. The controller 130 may estimate the collision position and the collision time with respect to the lateral side of the host vehicle.

Referring to FIG. 9 again, if a collision is unavoidable, the controller 130 may change the traveling state of the host vehicle to a state where the impact resulting from the collision is reduced (S160).

The controller 130 may determine the traveling state of the host vehicle with respect to the state where the impact resulting from the collision is reduced based on the determined collision position and collision time. The controller 130 may determine whether or not there are candidate collision areas that may receive an impact amount smaller than that in the collision area in which the estimated impact amount is determined on the lateral side of the host vehicle.

When there are candidate collision areas, the controller 130 may determine whether or not there are candidate collision areas where a collision with the target vehicle can be induced according to the change of the traveling state of the host vehicle. The controller 130 may determine the collision area that receives the smallest impact amount among the candidate collision areas where the collision can be induced.

According to an example, the determination of the impact amount may be determined by weighting the impact amount on a passenger who is present in the vehicle, rather than the impact amount on the host vehicle. That is, when the impact amount on an area corresponding to a seat portion and the impact amount on an area corresponding to the trunk portion are the same in the lateral sides of the vehicle, the area corresponding to the trunk portion may be determined as the collision area. Further, the determination of the impact amount may be determined differently depending on whether or not a passenger is present.

The controller 130 may determine the traveling state of the host vehicle that causes the target vehicle to collide with the determined impact area. The controller 130 may determine the change value of the traveling state based on the determined traveling state of the host vehicle and the current traveling state of the host vehicle.

When the collision area is determined, the controller 130 may further determine the traveling state in which the impact amount is reduced in the determined collision area. The controller 130 may determine the damping force of the suspension of the host vehicle or the height of the suspension that causes the impact amount to be reduced in the determined collision area. In addition, the controller 130 may determine the longitudinal position and height of a seat, the inclination of the backrest of the seat, and the like that causes the impact amount to be reduced in the determined collision area.

The controller 130 may change at least one of the vehicle speed, the steering, the suspension, or the seat position of the host vehicle, which are aspects of the traveling state of the host vehicle, based on changed values of the determined traveling state.

Referring to FIG. 9 again, when a collision with the target vehicle is avoidable, the controller 130 may change the traveling state of the host vehicle so as to avoid a collision (S170).

If a collision is avoidable, the controller 130 may output a signal for driving the collision avoidance system provided in the host vehicle. The collision avoidance system is well known in the art, and a detailed description thereof will be omitted.

According to this, if the collision of the target vehicle with a lateral side of the host vehicle is unavoidable, it is possible to minimize the damage in a side collision by changing the traveling state of the vehicle.

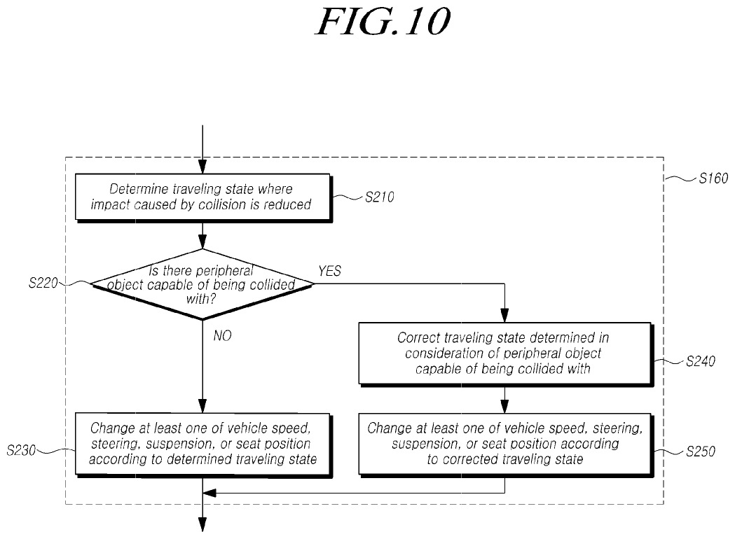

FIG. 10 is a flowchart of a vehicle collision mitigation method in consideration of peripheral objects according to the present disclosure.

The step of changing the traveling state of the host vehicle to a state in which the impact resulting from the collision described above with reference to FIG. 9 is reduced (S160) is performed in more detailed steps depending on whether or not a collision with a peripheral object may occur after the collision with the target vehicle.

Referring to FIG. 10, the controller 130 may determine a traveling state in which an impact resulting from a collision is reduced (S210).

This is performed according to step S160, described above with reference to FIG. 9, and a detailed description thereof is omitted in order to avoid redundant description.

Referring to FIG. 10 again, the controller 130 may determine whether or not there is a peripheral object capable of being collided with (S220).

The second sensor provided in the vehicle collision mitigation apparatus 100 may further sense the peripheral information of the vehicle 20 including a lane and a peripheral object. The second sensor may sense objects detected within a predetermined range with reference to the host vehicle, such as a vehicle or a guard rail, in addition to the target vehicle.

The controller 130 may determine the position of a peripheral object with reference to the host vehicle according to the current traveling state of the host vehicle. When the peripheral object is another vehicle, the controller 130 may determine the path of the other vehicle based on the sensed position of the other vehicle.

Referring to FIG. 10 again, when there is no peripheral object capable of being collided with, the controller 130 may change at least one of a vehicle speed, steering, a suspension, or a seat position depending on the determined traveling state (S230).

This is performed according to step S160, described above with reference to FIG. 9, and a detailed description thereof is omitted in order to avoid redundant description.

Referring to FIG. 10 again, when there is a collision-related peripheral object, the controller 130 may correct the determined traveling state in consideration of the peripheral object capable of being collided with (S240).

The controller 130 may determine whether a collision with the peripheral object occurs after a collision with the target vehicle based on the peripheral information. If a collision with the peripheral object occurs, the controller 130 may correct the previously determined traveling state of the host vehicle to the traveling state in which the impact amount at the time of the collision is minimized, based on the impact caused by the collision with the peripheral object.

Referring to FIG. 10 again, the controller 130 may change at least one of a vehicle speed, steering, a suspension, or a seat position depending on the corrected traveling state (S250).

Since this is substantially the same as the control for changing the vehicle speed, the steering, the suspension, and the seat position as described above, a detailed description thereof will be omitted in order to avoid redundant description.

According to this, if the collision of the target vehicle with a lateral side of the host vehicle is unavoidable, it is possible to minimize the damage in a side collision by further taking into account the peripheral information of the vehicle.

None of the claims in this application as filed are intended to be interpreted as having means-plus-function elements. Should Applicant wish to invoke Section 112(f) during prosecution, it will recite claim elements using the “means for” [performing a function] construct.

The present disclosure described above may be implemented as computer-readable code in a medium in which a program is recorded. The computer-readable medium includes all kinds of storage devices in which data that can be read by a computer system are stored. Examples of the computer-readable medium include a Hard Disk Drive (HDD), a Solid-State Disk (SSD), a Silicon Disk Drive (SDD), a ROM, a RAM, a CD-ROM, a magnetic tape, a floppy disk, and an optical data storage device, and may also be implemented in the form of a carrier wave (e.g., transmission over the Internet). The computer may also include the controller 130 of the present disclosure.

The above description and the accompanying drawings provide an example of the technical idea of the present disclosure for illustrative purposes only. Those having ordinary knowledge in the technical field, to which the present disclosure pertains, will appreciate that various modifications and changes in form, such as combination, separation, substitution, and change of a configuration, are possible without departing from the essential features of the present disclosure. Therefore, the embodiments disclosed in the present disclosure are intended to illustrate the scope of the technical idea of the present disclosure, and the scope of the present disclosure is not limited by the embodiment. That is, at least two elements of all structural elements may be selectively joined and operate without departing from the scope of the present disclosure. The scope of the present disclosure shall be construed based on the accompanying claims in such a manner that all of the technical ideas included within the scope equivalent to the claims belong to the present disclosure.

What is claimed is:

1. An apparatus for assisting driving of a host vehicle, comprising:
at least one first sensor detecting vehicle information of the host vehicle;
at least one second sensor detecting a target vehicle around the host vehicle; and
a controller configured to:
determine a path of the host vehicle based on vehicle information of the host vehicle;
determine a path of the target vehicle based on a result of detecting the target vehicle;
determine whether a collision of the target vehicle with a lateral side of the host vehicle is unavoidable based on the path of the host vehicle and the path of the target vehicle; and
change a traveling state of the host vehicle to a state in which an impact caused by the collision is reduced if the collision is unavoidable,
wherein the controller is further configured to:
determine the state in which the impact is reduced, based on an estimated impact amount for the host vehicle and a passenger of the host vehicle determined based on an estimated position of the collision, and
determine the estimated impact amount by weighting an impact amount on the passenger than an impact amount on the host vehicle.

2. The apparatus of claim 1, wherein the traveling state comprises at least one of a vehicle speed, steering, a suspension, or a seat position of the host vehicle, and
if the collision is unavoidable, the controller estimates a collision area and a collision time with respect to a lateral side of the host vehicle, and changes at least one of the vehicle speed, the steering, the suspension, or the seat position of the host vehicle based on the estimated result.

3. The apparatus of claim 2, wherein, if the collision is unavoidable, the controller changes at least one of the vehicle speed or the steering of the host vehicle such that the target vehicle collides with a collision area where an impact amount at a time of collision is smaller than the estimated collision area in the lateral side of the host vehicle.

4. The apparatus of claim 3, wherein, if the collision is unavoidable, the controller changes at least one of a damping force of the suspension or a height of the host vehicle determined with reference to the suspension.

5. The apparatus of claim 3, wherein, if the collision is unavoidable, the controller changes at least one of a height of the seat, an inclination of a backrest of the seat, or a longitudinal position of the seat.

6. The apparatus of claim 1, wherein the at least one second sensor further detects peripheral information of the host vehicle comprising a lane and a peripheral object, and
the controller changes the traveling state of the host vehicle to a state in which a collision with the peripheral object, which is likely to occur after the collision with the target vehicle, is prevented or to a state in which an impact caused by the collision with the peripheral object is reduced based on the peripheral information.

7. A method for assisting driving of a host vehicle, the method comprising:
detecting vehicle information of the host vehicle;
detecting a target vehicle around the host vehicle;
determining a path of the host vehicle based on vehicle information of the host vehicle;
determining a path of the target vehicle based on a result of detecting the target vehicle;
determining whether a collision of the target vehicle with the lateral side of the host vehicle is unavoidable based on the path of the host vehicle and the path of the target vehicle; and
changing the traveling state of the host vehicle to a state in which an impact caused by the collision is reduced if the collision is unavoidable,
wherein the changing the traveling state of the host vehicle further comprising:
determining an estimated impact amount for the host vehicle and a passenger of the host vehicle determined based on an estimated position of the collision, and
determining the estimated impact amount by weighting an impact amount on the passenger than an impact amount on the host vehicle.

8. The method of claim 7, wherein, if the collision is unavoidable, the determining whether the collision includes estimating a collision area and a collision time with respect to a lateral side of the host vehicle, and
wherein the changing the traveling state of the host vehicle includes changing at least one of the vehicle speed, the steering, the suspension, or the seat position of the host vehicle based on the estimated result

9. The method of claim 8, wherein, if the collision is unavoidable, the changing the traveling state of the host vehicle includes changing at least one of the vehicle speed or the steering of the host vehicle such that the target vehicle collides with a collision area where an impact amount at a time of collision is smaller than the estimated collision area in the lateral side of the host vehicle.

10. The method of claim 9, wherein, if the collision is unavoidable, the changing the traveling state of the host vehicle includes changing at least one of a damping force of the suspension or a height of the host vehicle determined with reference to the suspension.

11. The method of claim 9, wherein, if the collision is unavoidable, the changing the traveling state of the host vehicle includes changing at least one of a height of the seat, an inclination of a backrest of the seat, or a longitudinal position of the seat.

12. The method of claim 7, wherein the changing the traveling state of the host vehicle includes changing the traveling state of the host vehicle to a state in which a collision with a peripheral object, which is likely to occur after the collision with the target vehicle, is prevented or to a state in which an impact caused by the collision with the peripheral object is reduced based on the peripheral information comprising a lane and the peripheral object.
